(19) United States
(12) Patent Application Publication
(10) Pub. No.: US 2024/0084125 A1
(43) Pub. Date: Mar. 14, 2024

(54) UV-CURABLE TAPE

(71) Applicant: 3M INNOVATIVE PROPERTIES COMPANY, St. Paul, MN (US)

(72) Inventors: Jonathan E. Janoski, Woodbury, MN (US); Andrew Satrijo, St. Paul, MN (US); Kathleen S. Schafer, Woodbury, MN (US); Adam O. Moughton, Minneapolis, MN (US)

(21) Appl. No.: 18/269,720

(22) PCT Filed: Dec. 23, 2021
(86) PCT No.: PCT/IB2021/062275

§ 371 Date: Jun. 26, 2023

Related U.S. Application Data
(60) Provisional application No. 63/132,566, filed on Dec. 31, 2020.

(51) Int. Cl. C08L 53/00; C08K 7/16

(52) U.S. Cl. CPC C08L 53/005; C08K 7/16; C08L 2205/18; C08L 2312/00

(57) ABSTRACT

A curable composition comprising 20 wt. % to 60 wt. %, optionally 30 wt. % to 58 wt. %, or optionally 40 wt. % to 55 wt. % of an acrylic block copolymer, 5 wt. % to 60 wt. %, optionally 20 wt. % to 50 wt. %, or optionally 15 wt. % to 45 wt. %, of an epoxy resin; 1 wt. % to 60 wt. %, optionally 5 wt. % to 50 wt. %, or optionally 15 wt. % to 45 wt. %, of a polyol; and 0.5 wt. % to 10 wt. %, optionally 0.75 wt. % to 8 wt. %, or optionally 1 wt. % to 5 wt. %, of a curing agent. The curable composition may be used to prepare a tape that is initially soft (i.e., low-modulus), which enables a water-tight seal during an electronics assembly process at ambient temperatures, and then cures after UV-activation into a more rigid (i.e., higher modulus) tape that has a desirable balance of impact resistance (both tensile and shear impact), dynamic shear resistance, and pushout resistance.

### TECHNICAL FIELD

The present disclosure relates generally to the field of adhesives, more specifically to the field of pressure sensitive adhesives and tapes and articles prepared therefrom, especially hot melt processable pressure sensitive adhesives including acrylic block copolymers and having a desirable balance of impact resistance, dynamic shear resistance, and pushout resistance.

### BACKGROUND

Adhesives may be used fora variety of marking, holding, protecting, sealing and masking purposes. Adhesive tapes generally comprise a backing, or substrate, and an adhesive. One type of adhesive, a pressure sensitive adhesive, is particularly preferred for many applications.

Pressure sensitive adhesives (“PSAs”) are well known to one of ordinary skill in the art to possess certain properties at room temperature including the following: (I) aggressive and permanent tack, (2) adherence with no mote than finger pressure, (3) sufficient ability to hold onto an adherend, and (4) sufficient cohesive strength to be removed cleanly from the adherend. Materials that have been found to function well as pressure sensitive adhesives are polymers designed and formulated to exhibit the requisite viscoelastic properties resulting in a desired balance of tack, peel adhesion. and shear strength. The most commonly used polymers for preparation of pressure sensitive adhesives are natural rubber, synthetic rubbers (e.g., styrene/butadiene copolymers (“SBR”) and styrene/isoprene/styrene (“SIS”) block copolymers), various (meth)acrylate (e.g., acrylate and methacrylate) copolymers and silicones.

### SUMMARY

Provided herein is a tape that is initially soft (i.e., low-modulus), which enables a water-tight seal during an electronics assembly process at ambient temperatures, and then cures after UV-activation into a more rigid (i.e., higher modulus) tape that has a desirable balance of impact resistance (both tensile and shear impact), dynamic shear resistance, and pushout resistance.

In one aspect, provided herein is a curable composition including
20 wt. % to 60 wt. %, optionally 30 wt. % to 58 wt. %, or optionally 40 wt. % to 55 wt. % of an acrylic block copolymer,
5 wt. % to 60 wt. %, optionally 20 wt. % to 50 wt. %, or optionally 15 wt. % to 45 wt. %, of an epoxy resin;
1 wt. % to 60 wt. %, optionally 5 wt. % to 50 wt. %, or optionally 15 wt. % to 45 wt. %, of a polyol; and
0.5 wt. % to 10 wt. %, optionally 0.75 wt. % to 8 wt. %, or optionally 1 wt. % to 5 wt. %, of a curing agent.

In another aspect, methods of preparing the curable composition of the present disclosure are provided, the method comprising:
combining the copolymer with an epoxy resin, polyol, curing agent, and
optionally coating the mixture.

Also provided are articles including the curable composition of the present disclosure as well as cured articles prepared from the curable composition of the present disclosure.

As used herein:
the terms “a”, “an”, and “the” are used interchangeably and mean one or more; and “and/or” is used to indicate one or both stated cases may occur, for example A and/or B includes, (A and B) and (A or B);
the term “(meth)acrylate” refers to polymeric material that is prepared from acrylates, methacrylates, or derivatives thereof;
the term “polymer” refers to a polymeric material that is a homopolymer or a copolymer. As used herein, the term “homopolymer” refers to a polymeric material that is the reaction product of one monomer,
the term “glass transition temperature” or “Tg” refers to the temperature at which a polymeric material transitions from a glassy state (e.g., brittleness, stiffness, and rigidity) to a rubbery state (e.g., flexible and elastomeric). The Tg can be determined, for example, using techniques such as Differential Scanning Calorimetry (“DSC”) or Dynamic Mechanical Analysis (“DMA”); and
the term “copolymer” refers to a polymeric material that is the reaction product of at least two different monomers.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

All numbers are herein assumed to be modified by the term “about” and preferably with the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, recitation of ranges by endpoints includes all numbers subsumed within that range (e.g., 1 to 10 includes 1.4, 1.9, 2.33, 5.75, 9.98).

Features and advantages of the present disclosure will be further understood upon consideration of the detailed description as well as the appended claims.

### DETAILED DESCRIPTION

In the consumer electronics industry, there is a need for electronic display bonding materials. For example, in mobile phone display bonding, a tape is needed that is resistant to both drops and impacts. Some electronics Original Equipment Manufacturers (“OEMs”) evaluate a tape candidate's drop resistance using a tensile impact test method, whereas other OEMs prioritize dynamic shear test methods. In actual phone device drops, both tensile and shear forces are present, so it is important for a display bonding tape to be resistant to impact forces in both tensile and shear directions.

Another tape property that is important is pushout resistance, which can be tested by debonding two rigid substrates in a slow tensile direction. Properties such as dynamic shear resistance and pushout resistance are generally exhibited by stiff, high-modulus tapes. Unfortunately, during the phone assembly process, stiff high-modulus tapes typically require high pressure and high temperature to make a water tight seal between two rigid substrates.

Provided herein are tapes that are initially soft (i.e., low-modulus), which enables a water-tight seal during the assembly process at room temperature, and then may be UV-cured into a rigid (i.e., high modulus) tape that has a balance of impact resistance (both tensile and shear impact), dynamic shear resistance, and pushout resistance. Such tapes can be made using curable compositions comprising 20 wt. % to 60 wt. % of an acrylic block copolymer, 5 wt. % to 60 wt. % of an epoxy resin, 1 wt. % to 60 wt. % of a polyol, and 0.5 wt. % to 10 wt. % of a curing agent.

### Acrylic Block Copolymer

The block copolymers of the present disclosure are acrylic block copolymers, comprising at least two A block polymeric units and at least one B block polymeric unit (i.e., at least two A block polymeric units are each covalently bonded to at least one B block polymeric unit). Each A block is derived from a first (meth)acrylate monomer and the B block is derived from second a (meth)acrylate monomer. The A block tends to be more rigid than the B block (i.e., the A block has a higher glass transition temperature than the B block). The A block is also referred to herein as a “hard block” and the B block is also referred to herein as a “soft block.” Acrylic block copolymers are differentiated from other acrylic copolymers in that they exhibit phase segregation at temperatures lower than the glass transition temperature of the end blocks. This leads to elastomeric properties below that temperature and the ability to compound solvent-free above that temperature. A consequence of this behavior may be superior roll stability and static shear performance of materials compounded with acrylic block copolymers compared to their random acrylic copolymer counterparts.

Curable compositions of the present disclosure commonly include 20 wt. % to 60 wt. %, optionally 30 wt. % to 58 wt. %, or optionally 40 wt. % to 55 wt. % of an acrylic block copolymer. The acrylic block copolymer commonly has a number average molecular weight (“Mn”) of 48 kD to 102 kD, optionally 65 kD to 101 kD, or optionally 75 kD to 100 kD.

In some preferred embodiments, the acrylic block copolymer comprises 7 wt. % to 51 wt. % of a hard block (“A block”) and 49 wt. % to 93 wt. % of a soft block (“B block”) based on the weight of the block copolymer. Higher amounts of the A block tend to increase the stiffness or modulus of the copolymer, which can be used to optimize properties of the composition such as the mechanical strength and modulus. In some preferred embodiments, one or both of the blocks is non-reactive during the UV-activated epoxy reaction (e.g. one or both blocks does not contain pendant epoxy or hydroxyl functionality). In some preferred embodiments, the hard block comprises polymethyl methacrylate. In some preferred embodiments, the soft block comprises polybutyl acrylate.

Methods of preparing acrylic block copolymers are known to those of skill in the art and are described, for example, in U.S. Pat. No. 6,806,320 (Everaerts et al.). Acrylic block copolymers useful in embodiments of the present disclosure are also commercially available, for example, from Kuraray CO., Tokyo, Japan under the trade designation “KURARITY.”

### Epoxy Resin

Curable compositions of the present disclosure commonly include 5 wt. % to 60 wt. %, optionally 20 wt. % to 50 wt. %, or optionally 15 wt. % to 45 wt. %, of an epoxy resin. A variety of commercially available epoxy resins can be utilized in curable compositions of the present disclosure. Typically, useful epoxy resins may have an epoxy equivalent weight of from 150 to 250.

In some embodiments, the epoxy resin may comprise a first epoxy resin and a second epoxy resin combined in a ratio of 0.5:1.5, optionally 0.75:1.25, or optionally 1:1. In some embodiments, the second epoxy resin has an epoxy equivalent weight of from about 500 to about 600.

In some preferred embodiments, the epoxy resin comprises a bisphenol A derived epoxy resin. Examples of such preferred epoxy resins include, without limitation, a difunctional bisphenol A/epichlorohydrin derived epoxy resin, commercially available under the trade designation “EPON 828” from Dow Inc., Midland, Michigan, and a difunctional bisphenol A/epichlorohydrin derived epoxy resin, commercially available under the trade designation “EPON 1001F” from Dow Inc., Midland, Michigan.

### Polyol

Curable compositions of the present disclosure preferably include 1 wt. % to 60 wt. %, optionally 5 wt. % to 50 wt. %, or optionally 15 wt. % to 45 wt. %, of a polyol. A variety of commercially available polyols can be utilized in curable compositions of the present disclosure. Typically, useful polyols will have a molecular weight of 500 g/mol to 14,000 g/mol and comprise a polyether polyol, a polyester polyol, and combinations thereof.

When higher molecular weight polyols (i.e., polyols having weight average molecular weights of at least about 2,000) are used, it is often desirable that the polyol component be “highly pure” (i.e., the polyol approaches its theoretical functionality—e.g., 2.0 for diols, 3.0 for triols, etc.). Such highly pure polyols generally have a ratio of polyol molecular weight to weight % hydroxyl equivalent weight of at least about 800, typically at least about 1,000, and more typically at least about 1,500. For example, a 12,000 molecular weight polyol with 8 weight % hydroxyl equivalent weight has such a ratio of 1,500 (i.e., 12,000/8=1,500).

Examples of highly pure polyols useful in embodiments of the present disclosure include those available from Covestro AG of Luverkusen, Germany., under the trade designation, ACCLAIM, and certain of those under the trade designation, ARCOL.

### Curing Agent

The curable composition further contains one or more curing agents. The term “curing agent” is used broadly to include not only those materials that are conventionally regarded as curatives but also those materials that catalyze or accelerate the reaction of the curable material, as well as, those materials that may act as both curative and catalyst or accelerator. It is also possible to use two or more curing agents in combination. The curing agent may be a heat-activated curative or a light-activated curative. The cure from a light-activated curative can optionally be accelerated by elevated temperature (e.g., 40-80° C.).

Suitable curing agents for use in embodiments of the present disclosure include, but are not limited to, curing agents disclosed in U.S. Pat. No. 4,503,211 (Robins); U.S. Pat. No. 4,751,138 (Tumey, et al.); and 10,774,245 (Emslander et al.), the disclosures of all of which are incorporated by reference in their entirety.

The amount of the photoinitiator used in the UV-curable pressure-sensitive adhesive composition in a reactive polyacrylate/epoxy resin hybrid system with reactive functional groups is very small, but the amount thereof has a great impact on the curing speed and storage stability of the UV-curable pressure-sensitive adhesive composition.

The photoinitiator may be a cationic photoinitiator, including but not limited to, onium salts and cationic organometallic salts, both of which are described in U.S. Pat. No. 5,709,948 and photoactivatable organometallic complex salts such as those described in U.S. Pat. Nos. 5,059,701; 5,191,101; and 5,252,694. Suitable cationic photoinitiators including but not limited to the following compounds: diaryl iodonium salt, triaryl sulfonium salt, alkyl sulfonium salt, iron aromatic hydrocarbon salt, sulfonyloxanone, and triaryl siloxane. In some embodiments, the following compounds are used: triarylsulfonium hexafluorophosphate salts or hexafluoroantimonate salts, sulfonium hexafluoroantimonate salts, sulfonium hexafluorophosphate salts, and iodonium hexafluorophosphate salts.

The onium salt photoinitiator applicable to the present invention includes, but not limited to, iodonium and sulfonium complex salts. Suitable aromatic iodonium complex salts are described more fully in U.S. Pat. No. 4,256,828. Useful aromatic iodonium complex salts include a salt of a general formula as follows:

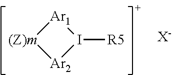

Ar₁ and Ar₂ are identical or different, each comprising aryl having about 4 to 20 carbon atoms. Z is selected from the group consisting of oxygen, sulfur, carbon-carbon bonds; 1.3 of

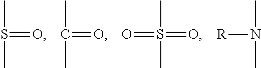

R may be aryl (having about 6 to 20 carbon atoms, such as phenyl) or acyl (having about 2 to 20 carbon atoms, such as acetyl or benzoyl); and

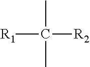

R₁ and R₂ are selected from the group consisting of hydrogen, alkyl having about 1 to 4 carbon atoms, and alkenyl having about 2 to 4 carbon atoms.

m is 0 or 1; and

X has a DQn chemical equation, where D is a metal in families 1B to VIII or nonmetal in families from IIIA to VA in the periodic table of elements, or a combination thereof, D also includes hydrogen; Q is halogen atom; and n is an integer within 1 to 6. The metal is preferably copper, zinc, titanium, vanadium, chromium, magnesium, manganese, iron, cobalt, or nickel, and the nonmetal is advantageously boron, aluminium, antimony, tin, arsenic and phosphorus. Halogen Q is preferably chlorine or fluorine. Suitable examples of anions include, but are not limited to, BF₄⁻, PF₆⁻, SbF₆⁻, FeCl₄⁻, SnCl₅⁻, AsF₆⁻, SbF₃OH⁻, SbCl₆⁻, SbF₅⁻², AIF₅⁻², GaCl₄⁻, InF₄⁻, TiF₆⁻², ZrF₆⁻, and CF₃SO₃⁻. The anions are preferably BF₄⁻, PF₆⁻, SbF₆⁻, AsF₆⁻, SbF₅OH⁻ and SbCl₆⁻ More preferably, the anions are SbF₆⁻, AsF₆⁻ and SbF₅OH

More preferably, Ar₁ and Ar₂ are selected from the group consisting of phenyl group, thienyl group, furanyl group, and pyrazolyl group. The An and An groups may optionally comprise one or a plurality of condensed benzocycles (e.g., naphthyl, benzothienyl, dibenzothienyl, benzofuranyl, and dibenzofuranyl). The aryl groups may also be substituted by one or a plurality of non-alkaline groups as required, if they do not substantially react with epoxy compounds and hydroxy functional groups.

Aromatic sulfonium complex salt initiators applicable to the present invention may be expressed by the following general formula:

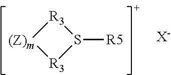

wherein R₃, R₄ and R₃ are identical or different, provided that at least one of R₃, R₄ and R₃ is aryl. R₃, R₄ and R₃ may be selected from the group consisting of aromatic portions comprising about 4 to 20 carbon atoms (e.g., substituted and unsubstituted phenyl, thienyl and furyl) and alkyl comprising about 1 to 20 carbon atoms. R₃, R₄ and R₃ are each preferably an aromatic portion; and Z, m, and X are all those as defined for the iodonium complex salt above.

If R₃, R₄ and R₃ are aromatic groups, they may optionally comprise one or a plurality of condensed benzocycles (e.g., naphthyl, benzothienyl, dibenzothienyl, benzofuranyl, and dibenzofuranyl). The aryl groups may also be substituted by one or a plurality of non-alkaline groups as required, if they do not substantially react with epoxy compounds and hydroxy functional groups.

In one example of the present invention, triaryl substituted salts such as triphenyl hexafluoroantimonate and p-phenyl (phenylthio) biphenyl sulfonium hexafiuoroantimonate are the desired sulfonium salts. Other sulfonium salts useful in the present invention are described more fully in U.S. Pat. Nos. 4,256,828 and 4,173,476.

The opium salt photoinitiators useful in the present invention are photosensitive in the ultraviolet region of the spectrum. However, they can be sensitized to the near ultraviolet and the visible range of the spectrum by sensitizers for known photolyzable organic halogen compounds. Illustrative sensitizers include colored aromatic polycyclic hydrocarbons, as described in U.S. Pat. No. 4,250,053, and sensitizers such as described in U.S. Pat. Nos. 4,256,828 and 4,250,053. Suitable sensitizers should be chosen so as to not interfere appreciably with the cationic cure of the epoxy resin in the adhesive composition.

Another type of photoinitiators applicable to the present invention includes photo-activable organic metallic complex salts, such as those described in U.S. Pat. No. 5,059,701 (Keipert), 5,191,101 (Palazzotto et al.), and 5,252,694 (Willett et al.). These organic metal cationic salts have a general formula as follows:

[(L₁)(L₂)Mₘ]e⁺X⁻

where Mₘ represents an element selected from families IVB, VB, VIB, VIIB, and VIII in the periodic table of elements, and is preferably Cr, Mo, W, Mn, Re, Fe or Co; L₁ represents no ligand, or 1 or 2 ligands that contribute x electrons, wherein the ligands may be the same or different, and each ligand may be selected from the group consisting of carbocyclic aromatic and heterocyclic aromatic compounds which are substituted and unsubstituted by substituted and unsubstituted alicyclic and cyclic unsaturated compounds. Each of the compounds may contribute 2 to 12 pi electrons to a valence shell of the metal atom M. L₁ is advantageously selected from the group consisting of substituted and unsubstituted η3-allyl, η5-cyclopentadienyl and η7-cycloheptane compounds, and 0-aromatics from 0-benzene and substituted 0-benzene compounds (e.g., xylene) and compounds with 2-4 fused rings, each ring being able to contribute 3 to 8 π electrons to the valence shell of metal atom M.

L₂ represents no ligand or one to three ligands that contribute an even number of a electrons, wherein the ligands may be the same or different, and each ligand may be selected from the group consisting of carbon monoxide, nitrite onium, triphenylphosphine, triphenylantimony, and phosphorus, arsenic, antimony derivatives, under the condition that the total charges contributed by L₁ and L₂ to Mₘ result in net residual positive charges to e of a complex.

e is an integer of 1 or 2, the residual charge in coordination with cations; and X is a halogen-containing anion in coordination, as stated above.

Examples of organic metal complex cationic salts suitable for use as the photo-activable catalysts in the present invention include, but not limited to, the following:
[(η6-benzene)(η5-cyclopentadienyl)Fe]⁺[SbF₆]⁻,
[(η6-toluene)(η5-cyclopentadienyl)Fe]⁺[AsF₆]⁻,
[(η6-xylene)(η5-cyclopentadienyl)Fe]⁺[SbF₆]⁻,
[(η6-isopropylbenzene)(η5-cyclopentadienyl)Fe]⁺[SbF₆]⁻,
[(η6-xylene (mixed isomer)(η5-cyclopentadienyl)Fe]⁺[SbF₆]⁻,
[(η6-xylene (mixed isomer)(η5-cyclopentadienyl)Fe]⁺[PF₆]⁻,
[(η6-O-xylene)(η5-cyclopentadienyl)Fe]⁺[CF₃SO₃]⁻,
[(η6-m-xylene)(η5-cyclopentadienyl)Fe]⁺[BF₄]⁻,
[(η6-1,3,5-trimethylbenzene)(η5-cyclopentadienyl)Fe]⁺[SbF₆]⁻,
[(η6-hexamethylbenzene)(η5-cyclopentadienyl)Fe]⁺[SbF₅OH]⁺,
[(η6-fluorene)(η5-cyclopentadienyl)Fe]⁺[SbF₆]⁻.

In one example of the present invention, the required organic metal complex cationic salts include one or more of the following compounds:
[(η6-xylene (mixed isomer)(η5-cyclopentadienyl)Fe]⁺[SbF₆]⁻,
[(η6-xylene (mixed isomer)(η5-cyclopentadienyl)Fe]⁺[PF₆]⁻,
[(η6-xylene)(η5-cyclopentadienyl)Fe]⁺[SbF₆]⁻,
[(η6-1,3,5-trimethylbenzene)(η5-cyclopentadienyl)Fe]⁺[SbF₆]⁻,

Suitable commercially-available initiators include, but not limited to, DOUBLECURE 1176, 1193 (Double Bond Chemical Ind. Co., Ltd.) and IRGACURE™ 261, and cationic organic metallic complex salts (BASF). Photoinitiators include, but not limited to, azo initiators and peroxide initiators, such as azobisisobutyronitrile (AIBN), azodiisoheptanitrile (ABVN), 2,2′-azo-bis-(2-methylbutyronitrile) (AMBN), benzoyl peroxide (BPO), and persulfate.

In the composition of the present invention, the content of the photoinitiator is 0.05 to 5 parts by weight, preferably 1-2 parts by weight. Generally speaking, the curing speed of the adhesive composition increases as a result of an increase of the content of the photoinitiator. When the amount of the used photoinitiator is too low, the required radiation energy of UV during curing is high, and the curing speed is slow. On the contrary, when the amount of the used photoinitiator is too great, the required radiation energy of UV during is very low and the curing speed is too fast. Even under sunlight or fluorescent lamp light (containing a small amount of UV light), the photoinitiator can be cured, thereby impacting the storage stability at mom temperature.

Curable compositions of the present disclosure commonly include 0.5 wt. % to 10 wt. %, optionally 0.75 wt. % to 8 wt. %, or optionally 1 wt. % to 0 5 wt. % of a curing agent. Commonly, the curing agent is selected from the group consisting of an amine curing agent, a photoinitiator, and combinations thereof.

### Optional Additives

The curable composition may optionally further contain one or more additives such as, for example, an additive selected from the group consisting of microspheres, a styrenic block copolymer, an epoxidized natural rubber, and combinations thereof. In some preferred embodiments, the curable composition comprises up to 5 wt. % of the microspheres, such as the expandable polymeric microspheres available under the trade designation DUALITE, from Chase Corp., Westwood, MA, USA. In some preferred embodiments, the curable composition comprises 10 wt. % of the styrenic block copolymer. In some preferred embodiments, the curable composition comprises up to 60 wt. % of the epoxidized natural rubber.

Curable compositions may also contain one or more additional conventional additives. Preferred additives may include, for example, tackifiers, plasticizers, dyes, antioxidants, UV stabilizers, and combinations thereof. Such additives can be used if they do not affect the superior properties of the pressure-sensitive adhesives.

If tackifiers are used, then up to 50% by weight, preferably less than 30% by weight, and more preferably less than 5% by weight, based on the dry weight of the curable composition would be suitable. In some embodiments no tackifier is used. Suitable tackifiers for use with (meth)acrylate polymer dispersions include a rosin acid, a rosin ester, a terpene phenolic resin, a hydrocarbon resin, and a cumarone indene resin. The type and amount of tackifier can affect properties such as contactability, bonding range, bond strength, heat resistance and specific adhesion.

Curable composition as disclosed herein may be prepared by methods know to those or ordinary skill in the relevant arts. For example, the curable composition may be prepared by combining the copolymer with an epoxy resin, polyol, curing agent, and optionally coating the mixture. In some embodiments, the combining step comprises melt blending. In some embodiments, the combining step comprises solvent blending.

Adhesive articles may be prepared by coating the curable composition on a suitable support, such as a flexible backing. Examples of materials that can be included in the flexible backing include polyolefins such as polyethylene, polypropylene (including isotactic polypropylene), polystyrene, polyester, polyvinyl alcohol, poly(ethylene terephthalate), poly(butylene terephthalate), poly(caprolactam), poly(vinylidene fluoride), polylactides, cellulose acetate, and ethyl cellulose and the like. Commercially available backing materials useful in the disclosure include silicone-coated polyester liners (available from Mitsubishi Polyester Film Inc., Greer, S.C.), kraft paper (available from Monadnock Paper, Inc.); cellophane (available from Flexel Corp.); spun-bond poly(ethylene) and poly(propylene), such as TYVEK and TYPAR (available from DuPont, Inc.); and porous films obtained from poly(ethylene) and poly(propylene), such as TESLIN (available from PPG Industries, Inc.), and CELLGUARD (available from Hoechst-Celanese).

Backings may also be prepared of fabric such as woven fabric formed of threads of synthetic or natural materials such as cotton, nylon, rayon, glass, ceramic materials, and the like or nonwoven fabric such as air laid webs of natural or synthetic fibers or blends of these. The backing may also be formed of metal, metalized polymer films, or ceramic sheet materials may take the form of any article conventionally known to be utilized with pressure-sensitive adhesive compositions such as labels, tapes, signs, covers, marking indicia, and the like.

The above-described curable compositions can be coated on a substrate using conventional coating techniques modified as appropriate to the particular substrate. For example, these curable compositions can be applied to a variety of solid substrates by methods such as roller coating, flow coating, dip coating, spin coating, spray coating knife coating, and die coating. The curable composition may also be coated from the melt. These various methods of coating allow the compositions to be placed on the substrate at variable thicknesses thus allowing a wider range of use of the compositions. Coating thicknesses may vary as required for a specific application.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted or readily apparent from the context, all parts, percentages, ratios, etc. in the Examples and the rest of the specification are by weight.

TABLE 1
Materials Used in the Examples

| Abbreviation | Description |
|---|---|
| LA2330 | M-B-M acrylic block copolymer with a M_{w} = 110 kDa, obtained under the trade |
| | designation “KURARITY LA2330” from Kuraray Co., Ltd., Tokyo, Japan |
| LA2140 | M-B-M acrylic block copolymer with a M_{w} = 66 kDa, obtained under the trade |
| | designation “KURARITY LA2140” from Kuraray Co., Ltd., Tokyo, Japan |
| 828 | Difunctional bisphenol A/epichlorohydrin derived epoxy resin, obtained under the |
| | trade designation “EPON 828” from Dow Inc., Midland, Michigan |
| 1001 | Difunctional bisphenol A/epichlorohydrin derived epoxy resin, obtained under the |
| | trade designation “EPON 1001F” from Dow Inc., Midland, Michigan |
| 2200 | 2,000 molecular weight propylene oxide polyether diol with low mono-ol, obtained |
| | under the trade designation “ACCLAIM 2200” from CovestroAG, Luverkusen, |
| | Germany |
| OMICURE | An aromatic substituted urea obtained under the trade designation “OMICURE U- |
| | 52M” from Huntsman Corporation, Woodlands, Texas |
| 6976 | A cationic UV photoinitiator containing a mixture |
| | of triarylsulfonium hexafluoroantimonate salts in propylene carbonate, obtained |
| | under the trade designation “UVI-6976” from Dow Inc., Midland, Michigan |
| ENR50 | Epoxidized natural rubber with 50% epoxide functional groups, obtained from Sanyo |
| | Corporation, New York, New York |
| 4454 | Polyacrylate elastomer which contains one or more acrylic esters with a small |
| | percentage of carboxy/chlorine cure sites, obtained under the trade designation |
| | “HYTEMP 4454” from ZEON Chemicals L.P., Louisville, Kentucky |
| D1119 | Kraton D1119 P is a clear, linear triblock copolymer based on styrene and isoprene |
| | with a polystyrene content of 22% from Kraton Polymers, Houston Texas |
| Q3620 | Polystyrene-polyisoprene synthetic rubber block copolymer, obtained under the trade |
| | designation “QUINTAC 3620” from ZEON Chemicals L.P., Louisville, Kentucky |
| DUALITE | Expandable polymeric microspheres, obtained under the trade designation, |
| | “DUALITE U025-170D” from Chase Corp., Westwood, Massachusetts |
| IRG 1010 | Sterically hindered phenolic primary antioxidant, obtained under the trade |
| | designation, IRGANOX 1010” from BASF, Florham Park, New Jersey |
| PET1 | Silicone-coated polyester liner, obtained under the trade designation “SILPHAN S75 |
| | B 0R30032/0R30022” from Siliconature S.P.A., Godega di Sant'Urbano, Italy |
| PET2 | Silicone-coated polyester liner, obtained under the trade designation “SILPHAN S50 |
| | D 0R30022” from Siliconature S.P.A., Godega di Sant'Urbano, Italy |
| CE-1 | 0.2 mm black, acrylic foam tape, obtained under the trade designation “VHB |
| | Electronic Tape 86420” from 3M Company, St. Paul, Minnesota |
| CE-2 | 0.2 mm acrylic tape, obtained under the trade designation “VHB Tape 4914-020” |
| | from 3M Company, St. Paul, Minnesota |
| 4013F | Low monol polyether polyol, can be obtained under the trade designation |
| | “PREMINOL S 4013F” from AGC Chemicals Americas, Inc., Exton, Pennsylvania |
| 250 | Cationic photoinitiator made of a blend of iodonium, (4-methylpheny1)[4- |
| | (2-methylpropyl) phenyl]-, hexafluorophosphate(1-) (75%) in propylene carbonate, |
| | obtained under the trade designation “OMNICAT 250” from IGM Resins USA Inc., |
| | Charlotte, North Carolina |
| ITX | 2-isopropylthioxanthone, obtained from Pfaltz and Bauer Inc., Waterbury, |
| | Connecticut |
| MMA | Methyl methacrylate, obtained from Alfa Aesar, Haverhill, Massachusetts |
| BA | Butyl acrylate, can be obtained from Millipore Sigma, St. Louis, Missouri |
| Ethyl Acetate | Ethyl acetate, can be obtained from Millipore Sigma, St. Louis, Missouri |
| VAZO 67 | 2,2′-azobis(2-methylbutanenitrile), can be obtained under the trade designation |
| | “VAZO 67” from The Chemours Company, Wilmington, Delaware |
| IOTG | Isooctyl thioglycolate, can be obtained from Millipore Sigma, St. Louis, Missouri |
| PI 2074 | 4-isopropyl-4′-methyldiphenyliodonium tetrakis(pentafluorophenyl)borate, a cationic |
| | photoinitiator obtained under the trade designation “BLUESIL PI 2074” from Elkem |
| | Silicones, East Brunswick, New Jersey |

Test Methods

Samples for peel adhesion and static shear adhesion testing were prepared by laminating the UV-curable pressure sensitive adhesive tape onto 0.13 mm thick anodized aluminum foil using a hand held rubber roller, except where noted. The test tape was irradiated with 4 J/cm2 (at ca. 1.1 W/cm2) from a 365 ran AC7300 LED light source (Excelitas Technologies, Waltham, MA, USA). The total UVA energy was determined using a POWER PUCK II radiometer equipped with a high power sensing head (available from EIT Incorporated, Sterling, VA). Stainless steel substrates were cleaned with methyl ethyl ketone, 1:1 isopropanol/water, acetone, and then dried with a KIMWIPE (Kimberly-Clark, Irving, TX) unless otherwise noted.

Peel Adhesion

A 12.5 mm wide strip of adhesive tape was applied to anodized aluminum foil, UV-activated, then laminated onto a 1.6 mm thick stainless steel panel using a 2.0 kg rubber roller to give a bonded article. The article was allowed to dwell for 72 hr at CM conditions. A 90° angle peel test was performed using an MTS Sintech 500/S at 30.5 cm/min peel rate, with data collected and averaged over 10 seconds, according to the test method ASTM Designation D3330/D330M-04. Uncured peel adhesion samples were prepared as above, except the UV-exposure step was skipped.

Static Shear Adhesion

Static Shear Adhesion was determined according to the test method of ASTM D3654/D3654M-06. A 25.4×12.7 mm UV-cured adhesive tape was applied to anodized aluminum foil, UV-activated, then laminated onto a 1.6 mm thick stainless steel panel using a 2.0 kg rubber roller to give a bonded article. The article was allowed to dwell for 24 hours before a 0.5 kg weight was attached to the assembly by the remaining length of aluminum foil that extended beyond the bonded area and held at 70° C. The time was measured when the adhesive sample failed to hold the weight. Samples were stopped at 10,000 min if they did not fail sooner.

Push Out Strength

A test tape sample with siliconized PET liners on both surfaces was cut in a circular ring geometry with a 3.11 cm outer diameter, 2.61 cm inner diameter (2.5 mm bond width). One liner was removed exposing the adhesive surface and the tape was adhered to the surface of a square polycarbonate test frame (4.07×4.07×0.3 cm) with a circular hole (2.4 cm diameter) cut in the middle; wherein the tape is centered over the hole. The second liner was removed from the test tape and the tape was irradiated with 4 J/cm2 of 365 nm UV-LED light. The total UVA energy was determined using a POWERPUCK II radiometer equipped with a high power sensing head (available from EIT Incorporated, Sterling, VA). Immediately after irradiation, a polycarbonate circular puck (3.3 cm diameter×0.3 cm thick) was centered over the test tape and adhered to the polycarbonate frame surface using a 10 kg weight which was placed on the bonded polycarbonate puck, tape, polycarbonate frame article for 10 seconds. The weight was removed and the testing fixture was allowed to dwell for 24 hr at CTH. An MTS Sintech 500/S (MTS, Eden Prairie, MN) was then used to separate the puck from the frame, which was held stationary, using a probe through the hole of the frame at a rate of 10 mm/min and the total force was recorded and three replicates were completed for each sample.

Tensile Impact

Samples were prepared as described in the Push Out Strength method, except the frame and puck substrates were made of stainless steel instead of polycarbonate. The samples were tested at a drop height of 300 mm with a 3 kg mass using an Instron CEAST 9340 Drop tower, wherein the impact was through the hole in the stationary frame such that the puck was separated from the frame. The total energy and failure mode were recorded and three replicates were completed for each sample.

Dynamic Shear

A stainless steel substrate (25.4×76.2×1.6 mm) was cleaned with methyl ethyl ketone, 1:1 isopropanol/water, acetone, and then dried with a KIMWIPE (Kimberly-Clark, Irving, TX). A 1” by 1” tape sample with PET liner on one surface was firmly bonded to the stainless steel substrate opposite the PET liner using finger pressure. The PET liner was then removed. The test tape was irradiated with 4 J/cm2 of 365 nm UV-LED light. The total UVA energy was determined using a POWER PUCK II radiometer equipped with a high power sensing head (available from EIT Incorporated, Sterling, VA). A second clean stainless steel substrate was bonded to the UV-cured tape. The sample was mechanically rolled with a 6.8 kg roller at 305 mm/min to ensure proper adhesion. The sample was allowed to dwell for 24 hr at CTH conditions. The substrates were attached to two separated jaw hooks in an MTS Insight 30 (MTS, Eden Prairie, MN) and separated at a rate of 12.7 nun/min.

Gel Content

All samples were cut out using a 2.54 cm diameter die, weighed, and then put into a pre-weighed metal pouch. The pouch was submerged in THE for three days. Pouches were taken out of solvent to dry in for 4 h in a 120° C. solvent oven (Blue M model DC-246AG-HP). The samples were then weighed again and the change in weight was recorded.

### Preparatory Example

### Synthesis of Preparatory Example 1 (PE1)

Methyl methacrylate (11 grams) was combined with butyl acrylate (39 grams) in a 200 mL glass jar equipped with a stir bar. Ethyl acetate (100 grams), IOTG (0.075 grams), and VAZO 67 (0.05 grams) were then added and the solution was purged by bubbling nitrogen through the solution for a period of 5 minutes, and then a lid was placed on the jar. The jar was placed in a water bath set to 70° C. on a stir plate for a period of 24 h. Solvent and residual monomer were removed by a vacuum oven set to 40° C. at a pressure of −30 in Hg.

### EXAMPLES

Examples CE-3 and EX-1 to EX-4 in Table 2 were prepared by combining the listed materials in a jar and rolling for 24 hours prior to coating. Tapes were prepared by pouring the solution onto PET1 then passed under a notch bar coater set with a gap of 24 mil (610 μm). The tape was then placed in a vented oven (Blue M model DC-246AG-HP) set to 70° C. for a period of 5 minutes. Two layers of each tape were laminated together to make a thicker sample.

TABLE 2
Compositions of UV-Activated Tapes for Investigating
the Effect of Polyol Concentration

| | Final | | | | | |
|---|---|---|---|---|---|---|
| | Thickness | LA2330 | 828 | 2200 | 6976 | Toluene |
| Example | (mm) | (wt. %) | (wt. %) | (wt. %) | (wt. %) | (wt. %) |
| CE-3 | 0.36 | 24.8 | 24.8 | 0.0 | 1.0 | 49.5 |
| EX-1 | 0.39 | 24.8 | 19.8 | 5.0 | 1.0 | 49.5 |
| EX-2 | 0.39 | 24.8 | 17.3 | 7.4 | 1.0 | 49.5 |
| EX-3 | 0.39 | 24.8 | 14.9 | 9.9 | 1.0 | 49.5 |
| EX-4 | 0.39 | 24.8 | 12.4 | 12.4 | 1.0 | 49.5 |

Examples EX-5 to EX-11 in Table 3 were prepared using a batch twin screw extruder with the following settings:
Extruder and melt train temperature: 250° F. (121° C.)
Hose and die temperature: 280° F. (138° C.)
Screw speed: 150 rpm
Liner. PET1

Upon exiting the die, the melt was coated on PET1 liner. The samples were then wound into a roll. Extruded samples were 80-145 μm thick transfer tapes. These tapes were then laminated up to double the thickness to between 160-290 μm.

TABLE 3
Compositions of UV-Activated Tapes Made Using a Batch Twin Screw Extruder

| | Final | | | | | | | | | |
|---|---|---|---|---|---|---|---|---|---|---|
| | Thickness | | | | | | | | | |
| Example | (mm) | LA2330 | LA2140 | 828 | 2200 | 6976 | ENR50 | 4454 | Q3620 | IRG1010 |
| EX-5 | 200 | 39.0 | 0.0 | 29.3 | 29.3 | 2.0* | 0.0 | 0.0 | 0.0 | 0.5 |
| EX-6 | 250 | 39.0 | 0.0 | 29.3 | 29.3 | 2.0 | 0.0 | 0.0 | 0.0 | 0.5 |
| EX-7 | 180 | 0.0 | 39.0 | 29.3 | 29.3 | 2.0 | 0.0 | 0.0 | 0.0 | 0.5 |
| EX-8 | 200 | 29.3 | 0.0 | 29.3 | 29.3 | 2.0 | 0.0 | 9.8 | 0.0 | 0.5 |
| EX-9 | 160 | 19.5 | 0.0 | 29.3 | 29.3 | 2.0 | 0.0 | 19.5 | 0.0 | 0.5 |
| EX-10 | 290 | 29.3 | 0.0 | 29.3 | 29.3 | 2.0 | 9.8 | 0.0 | 0.0 | 0.5 |
| EX-11 | 250 | 29.3 | 0.0 | 29.3 | 29.3 | 2.0 | 0.0 | 0.0 | 9.8 | 0.5 |

*PI 2074/ITX (1:1) was used instead of CPI 6976

Examples EX-12 to EX-19 in Table 4 were prepared using a 12-zone, continuous hot melt extruder with the average temperature of 250° F. (121° C.) and a screw speed of 500 rpm.

Liner 1: PET1

Liner 2: PET2

Upon exiting the die, the melt was coated on PET1 liner and then laminated with PET2 liner. The samples were then wound into a roll.

TABLE 4
Compositions of UV-Activated Tapes Made Using a Continuous Twin Screw Extruder

| | Final | | | | | | | | |
|---|---|---|---|---|---|---|---|---|---|
| | Thickness | | | | | | | | |
| Example | (mm) | LA2330 | 828 | 2200 | 6976 | 1001 | IRG1010 | Q3620 | DUALITE |
| EX-12 | 200 | 29.1 | 29.1 | 29.1 | 1.9 | | 1.0 | 9.7 | 0.0 |
| EX-13 | 250 | 38.8 | 29.1 | 29.1 | 1.9 | | 1.0 | 0.0 | 0.0 |
| EX-14 | 180 | 48.5 | 24.3 | 24.3 | 1.9 | | 1.0 | 0.0 | 0.0 |
| EX-15 | 200 | 34.0 | 29.1 | 29.1 | 1.9 | | 1.0 | 4.9 | 0.0 |
| EX-16 | 160 | 38.5 | 28.8 | 28.8 | 1.9 | | 1.0 | 0.0 | 1.0 |
| EX-17 | 290 | 48.1 | 24.0 | 24.0 | 1.9 | | 1.0 | 0.0 | 1.0 |
| EX-18 | 250 | 33.7 | 28.8 | 28.8 | 1.9 | | 1.0 | 4.8 | 1.0 |
| EX-19 | 210 | 50 | 22 | 8 | 2 | 20 | 1.0 | | |

Examples EX-20 and CE-4 in Table 5 were prepared by combining the listed materials in a jar and rolling for 24 hours prior to coating. Tapes were prepared by pouring the solution onto PET1 then passed under a notch bar coater set with a gap of 24 mil (610 μm). The tape was then placed in a vented oven (Blue M model DC-246AG-HP) set to 70° C. for a period of 5 minutes. Two layers of each tape were laminated together to make a thicker sample.

TABLE 5
Preparation of Tapes for Comparing Random to Block Acrylic Copolymers

| | Final | | | | | | | |
|---|---|---|---|---|---|---|---|---|
| | Thickness | | | | | | | |
| Example | (mm) | LA2330 | PE1 | 828 | 4013F | ITX | 250 | Q3620 |
| EX-20 | 200 | 34.0 | 0.0 | 29.1 | 29.1 | 1.0 | 1.9 | 4.9 |
| CE-4 | 250 | 0.0 | 34.0 | 29.1 | 29.1 | 1.0 | 1.9 | 4.9 |

TABLE 6
Adhesion Properties of UV-Activated Tapes

| | 90° Peel Adhesion | | Static | Dynamic | Push Out | | |
|---|---|---|---|---|---|---|---|
| | (lbs/in width) | | Shear | Shear | Strength | Tensile Impact | Gel Content |
| Example | Uncured | Cured | (min) | (N/mm) | (N) | Strength(J) | (% Wt. Loss) |
| CE-1 | | | 3100 | 1.18 | 168 | 1.01 | |
| CE-2 | | | >10,000 | 1.25 | 274 | 0.37 | |
| CE-3 | | | | | | | 93 |
| EX-1 | | | >10,000 | | 819 | | 83 |
| EX-2 | | | >10,000 | | 865 | | 74 |
| EX-3 | | | >10,000 | | 709 | | 66 |
| EX-4 | | | >10,000 | | 585 | | 50 |
| EX-5 | | | >10,000 | | 109 | | |
| EX-6 | | | >10,000 | 1.91 | 465 | 0.83 | |
| EX-7 | | | >10,000 | 2.14 | 577 | 1.24 | |
| EX-8 | | | >10,000 | 2.12 | 382 | 1.27 | |
| EX-9 | | | >10,000 | 0.54 | 73 | 1.09 | |
| EX-10 | | | >10,000 | 2.94 | 201 | 0.87 | |
| EX-11 | | | >10,000 | 3.09 | 667 | 1.80 | |
| EX-12 | 1.24 | 9.32 | >10,000 | 2.03 | 239 | 1.16 | |
| EX-13 | 3.79 | 11.13 | >10,000 | 2.00 | 231 | 0.68 | |
| EX-14 | 5.11 | 10.54 | >10,000 | 1.28 | 138 | 0.51 | |
| EX-15 | 1.78 | 9.33 | >10,000 | 1.91 | 271 | 1.05 | |
| EX-16 | 2.82 | 8.85 | >10,000 | 2.33 | 138 | 0.55 | |
| EX-17 | 7.29 | 10.07 | >10,000 | 2.88 | 233 | 0.58 | |
| EX-18 | 2.05 | 9.12 | >10,000 | 2.47 | 271 | 0.99 | |
| EX-19 | 3.39 | | >10,000 | 7.32 | 1041 | 0.194 | |
| EX-20 | | | >10,000 | 0.97 | 318 | 0.46 | |
| CE-4 | | | 0 | 0.15 | 50 | 0.45 | |

TABLE 7
Rheology Data for Select UV-Activated Tapes

| | Cured E′ at 23° C. | Cured Tan(δ) max |
|---|---|---|
| Example | (pa) | (° C.) |
| CE-3 | 4.50E+08 | 128 |
| EX-1 | 4.75E+08 | 81 |
| EX-2 | 3.37E+08 | 57 |
| EX-3 | 8.32E+07 | 40 |
| EX-4 | 6.17E+06 | 21 |
| EX-12 | 3.70E+06 | 14 |
| EX-13 | 2.93E+06 | 19 |
| EX-14 | 2.60E+06 | 30 |
| EX-15 | 3.67E+06 | 17 |

Epoxidized natural rubber ENR50 solutions were prepared by masticating the ENR50 with an extruder with a screw rate of 400 rpm for 4 minutes and then dissolving in toluene to obtain a 35 wt. % solution. The ENR50 solution was combined with 828, D1119, and curing catalyst as shown in Table 8. The materials were coated at a 12 mil wet gap onto the silicone surface of PET1 liner using a notch bar and dried at 74° C. (165° F.) fora period of 9 minutes. After drying the silicone surface of PET1 liner was laminated to make an adhesive transfer tape.

TABLE 8
Curable Adhesive Tapes with Epoxidized Natural Rubber,
Styrenic Block Copolymer, and Epoxy Resin

| | | | | | | Uncured Peel | Cured Peel |
|---|---|---|---|---|---|---|---|
| Example | ENR50 | 828 | D1119 | OMICURE | 6976 | (N/cm) | (N/cm) |
| EX-21 | 50 | 8.75 | 0.0 | 4.3 | 0.0 | 1.67 | 40.3 |
| EX-22 | 107 | 50 | 0.0 | 0.0 | 0.5 | 4.72 | 29.7 |
| EX-23 | 35.71 | 50 | 37.5 | 7 | 0.0 | 0.04 | 20.0 |
| EX-24 | 71.43 | 50 | 25 | 7 | 0.0 | 2.91 | 33.7 |
| EX-25 | 107.14 | 50 | 12.5 | 7 | 0.0 | 5.28 | 36.4 |

1. A curable composition comprising:
20 wt. % to 60 wt. %, optionally 30 wt. % to 58 wt. %, or optionally 40 wt. % to 55 wt. % of an acrylic block copolymer;
wt. % to 60 wt. %, optionally 20 wt. % to 50 wt. %, or optionally 15 wt. % to 45 wt. %, of an epoxy resin;
1 wt. % to 60 wt. %, optionally 5 wt. % to 50 wt. %, or optionally 15 wt. % to 45 wt. %, of a polyol; and
0.5 wt. % to 10 wt. %, optionally 0.75 wt. % to 8 wt. %, or optionally 1 wt. % to 5 wt. %, of a curing agent.

2. The curable composition of claim 1, wherein the acrylic block copolymer comprises 7 wt. % to 51 wt. % of a hard block and 49 wt. % to 93 wt. % of a soft block.

3. The curable composition of claim 2, wherein the hard block comprises polymethyl methacrylate.

4. The curable composition of claim 2, wherein the soft block comprises polybutyl acrylate.

5. The curable composition of claim 1, wherein the acrylic block copolymer has a number average molecular weight of 48 kD to 102 kD, optionally 65 kD to 101 kD, or optionally 75 kD to 100 kD.

6. The curable composition of claim 1, wherein the epoxy resin has an epoxy equivalent weight of from 150 to 250.

7. The curable composition of claim 1, wherein the epoxy resin comprises a first epoxy resin and a second epoxy resin combined in a ratio of 0.5:1.5, optionally 0.75:1.25, or optionally 1:1.

8. The curable composition of claim 7, wherein a second epoxy resin has an epoxy equivalent weight of from about 500 to about 600.

9. The curable composition of claim 1, wherein the epoxy resin comprises a bisphenol A derived epoxy resin.

10. The curable composition of claim 1, wherein the polyol has a molecular weight of 500 g/mol to 14,000 g/mol.

11. The curable composition of claim 1, wherein the polyol comprises a polyether polyol, a polyester polyol, and combinations thereof.

12. The curable composition of claim 1, wherein the curing agent is selected from the group consisting of an amine curing agent, a photoinitiator, and combinations thereof.

13. The curable composition of claim 1, wherein the curable composition further comprises an additive selected from the group consisting of microspheres, a styrenic block copolymer, an epoxidized natural rubber, and combinations thereof.

14. The curable composition of claim 13, wherein the curable composition comprises up to 5 wt. % of the microspheres.

15. The curable composition of claim 13, wherein the curable composition comprises up to 10 wt. % of the styrenic block copolymer.

16. The curable composition of claim 13, wherein the curable composition comprises up to 60 wt. % of the epoxidized natural rubber.

17. An article comprising the curable composition of claim 1.

18. A cured composition prepared from the curable composition of claim 1.

19. The cured composition of claim 18, wherein the cured composition has an impact strength of 0.4 to 1.8 Joules as measured by Tensile Impact test method.

20. The cured composition of claim 18, wherein the cured composition has a push out strength of 50 to 1040 Joules as measured by Push Out Strength test method.

21-25. (canceled)
